(19) United States
(12) Patent Application Publication
(10) Pub. No.: US 2016/0312744 A1
(43) Pub. Date: Oct. 27, 2016

(54) PROPULSION CHAMBER FOR A ROCKET AND METHOD FOR PRODUCING SUCH A CHAMBER

(71) Applicant: SNECMA, Paris (FR)

(72) Inventor: Robert GAZAVE, Panilleuse (FR)

(73) Assignee: SNECMA, Paris (FR)

(21) Appl. No.: 15/029,920

(22) PCT Filed: Oct. 10, 2014
(86) PCT No.: PCT/FR2014/052588

§ 371 Date: Apr. 15, 2016

(30) Foreign Application Priority Data
Oct. 16, 2013 (FR) 1360067

(51) Int. Cl. F02K 9/64

(52) U.S. Cl. CPC F02K 9/64; F05D 2300/603; F05D 2230/60

(57) ABSTRACT

A rocket propulsion chamber and a method of fabricating such a propulsion chamber are provided. The propulsion chamber includes a combustion chamber, a wall of the combustion chamber having a cooling circuit wherein a first propellant flows. A thermostructural composite material shell is placed against the outside of the combustion chamber and including a diverging nozzle extending beyond the bottom end of the combustion chamber, wherein a fraction of the thermostructural composite material shell is covered in a radially strong outer reinforcing shell for containing deformation of the combustion chamber and thermostructural composite material shell, the thermostructural composite material shell and the outer reinforcing shell forming a unitary assembly.

### FIELD OF THE INVENTION

The present invention relates to a rocket propulsion chamber.

More particularly, the invention relates to the structure of a rocket propulsion chamber and to a method of fabricating such a propulsion chamber.

### STATE OF THE PRIOR ART

A known type of rocket propulsion chamber comprises a combustion chamber made of metal, e.g. copper, with a cooling circuit included in the thickness of the wall of said combustion chamber and passing a flow of one of two propellants. Usually, the metal combustion chamber cooled by a cooling circuit comprises a metal shell that is capable of withstanding pressure, and referred to as a “structural shell”.

Such a combustion chamber is extended by a diverging nozzle made of thermostructural composite material that does not include an internal cooling circuit.

The main drawback of that type of propulsion chamber lies in the difficulty in assembling the combustion chamber made of metal with the diverging nozzle made of thermostructural composite material. It is difficult to provide a good mechanical connection between the combustion chamber and the diverging nozzle since the metal and the thermostructural composite material have different coefficients of expansion.

That type of combustion chamber also presents the drawback of being heavy and of leading to considerable fabrication costs.

In the publication of German patent application DE 10 2010 043 336 A1, there is disclosed a propulsion chamber that includes, around the combustion chamber, a shell of thermostructural composite material together with an outer reinforcing shell. Nevertheless, that combustion chamber is relatively complex to assemble.

### SUMMARY OF THE INVENTION

An object of the present invention is to remedy the above-mentioned drawbacks at least substantially.

The invention achieves its object by proposing a rocket propulsion chamber comprising a combustion chamber, a wall of the combustion chamber having a cooling circuit in which a first propellant flows, with a single-piece thermostructural composite material shell placed against the outside of said combustion chamber and including a diverging nozzle extending beyond the bottom end of the combustion chamber, and at least a fraction of said thermostructural composite material shell is covered in a radially strong outer reinforcing shell for containing deformation of the combustion chamber and of said thermostructural composite material shell, the thermostructural composite material shell and the outer reinforcing shell forming a unitary assembly, said combustion chamber bearing against an abutment fastened to the inside of a top part of the diverging nozzle.

It can be understood that the combustion chamber is received in full inside the thermostructural composite material shell, said thermostructural composite material shell fitting closely to part of the shape of the combustion chamber. For example, the thermostructural composite material shell may be made of carbon-silicon or carbon-carbon composite material.

It can also be understood that the thermostructural composite material shell is a “single-piece” part having a diverging nozzle that extends beyond the combustion chamber. Thus, by means of this solution, the problem of connecting the diverging nozzle to the combustion chamber is obviated.

Furthermore, it can be understood that the combustion chamber is held inside the thermostructural composite material by a fastener system.

In addition, the outer reinforcing shell preferably covers that portion of the thermostructural composite material shell that is level with the combustion chamber. This outer reinforcing shell serves to limit deformation of the combustion chamber and of the thermostructural composite material shell, where such deformation is due to the pressure generated inside the combustion chamber. Advantageously, the outer reinforcing shell is also made of composite material such as thermoplastic reinforced by carbon fibers, or such as a winding or a woven fabric of carbon fibers included in a solidified resin, preferably an epoxy or a phenolic resin.

By means of this configuration, the combustion chamber can be inserted inside the thermostructural composite material shell through the diverging nozzle, thereby making it easier to produce the propulsion chamber compared with prior art combustion chambers that need to be inserted through an opening in the top end of the thermostructural composite material shell.

In certain embodiments, the combustion chamber comprises in succession a dome for admitting a second propellant, a set of injectors, a substantially cylindrical portion extended by a converging portion and by a diverging portion, an inlet of the dome for admitting the first propellant constituting a top end of the combustion chamber and being connected to a feed duct for a second propellant. Thus, the dome or admitting the second propellant lies above the substantially cylindrical portion of the combustion chamber and is connected to the set of injectors.

It can therefore be understood that the feed duct for the second propellant is connected to the top end of the combustion chamber, passing through a hole made in the unitary assembly.

In these embodiments, the thermostructural composite material shell may also have a dome surmounting the dome of the combustion chamber. Thus, the dome of the single-piece thermostructural composite material shell also reinforces the dome for admitting the second propellant into the combustion chamber.

In particular, the combustion chamber may be held in said unitary assembly between an abutment fastened to the top end of the combustion chamber through which said admission duct for the second propellant passes, bearing against the top of said unitary assembly, and the abutment fastened to the inside of the top part of the diverging nozzle.

The combustion chamber is thus held axially between these two abutments, inside the unitary assembly.

In certain embodiments, an inlet tube for the first propellant is connected to the cooling circuit of the combustion chamber and passes through an opening formed in the unitary assembly.

In certain embodiments, the inlet tube for the first propellant opens out into an annular cavity having an inside face forming a portion of the wall of the combustion chamber situated at the junction between the converging and diverging portions thereof.

By means of these provisions, prior to being delivered to the cooling circuit, the first propellant begins by feeding the annular cavity and is spread in regular manner all around the combustion chamber inside the annular cavity, prior to penetrating into the cooling circuit.

In certain embodiments, the annular cavity is closed by a shroud that is fastened via its two axial ends to the wall of the combustion chamber, the shroud being surrounded by the unitary assembly and being pierced to pass the end of the inlet tube for the first propellant. For example, the wall of the combustion chamber may be made of metal.

In certain embodiments, the shroud carries internally a fastener plate having connected thereto the end of the inlet tube for the first propellant, the fastener plate including an opening for passing the first propellant.

Advantageously, the inlet tube for the first propellant is fastened to the fastener plate, which is preferably made of metal. This provision serves to avoid connecting the metal inlet tube to the unitary assembly.

In certain embodiments, the shroud carries internally at least two bases, each of which has a respective connection tab of a control actuator fastened thereto through a respective opening formed in the unitary assembly, in order to steer the propulsion chamber.

Likewise, this provision makes it possible to avoid the problem of connecting metal connection tabs to the unitary assembly.

In certain embodiments, the two connection tabs are offset circumferentially from each other by 90°.

In certain embodiments, the cooling circuit comprises:
cooling channels formed in the thickness of the wall of the combustion chamber, in which the first propellant flows upwards, these cooling channels extending between the diverging portion of the combustion chamber and a set of injectors arranged in the top portion of the combustion chamber; and
feed channels extending in the thickness of the diverging portion of the combustion chamber and in which the first propellant flows downwards, said feed channels communicating at their top ends via holes with the annular cavity, and via their bottom ends with the set of cooling channels.

Advantageously, in this example, the wall of combustion chamber has a thin metal covering closing and individualizing the cooling channels. By way of example, the covering may be made by conventional electrolyte deposition.

In addition, it can be understood that once the first propellant penetrates into the annular cavity, it is distributed into the feed circuit. To do this, it can be understood that the holes allowing the first propellant to pass from the annular cavity to the feed channels are arranged in the wall of the combustion chamber and more precisely, in this example, in said metal covering.

It can also be understood that the feed channels extend over a fraction of the diverging portion of the combustion chamber from their top ends in communication with said holes. It can thus be understood that a fraction of the first propellant reaching the bottom ends of the feed channels, advantageously arranged at the bottom end of the diverging portion of the combustion chamber, rises via the cooling channels to the top portion of the combustion chamber where the set of injectors is located.

By means of this provision, the first propellant is well distributed among the cooling channels, all around the combustion chamber.

In certain embodiments, the feed channels communicate with ejection orifices for passing a flow of the first propellant.

It can be understood that the first propellant is ejected by the ejection orifices and flows along the inside surface of the diverging nozzle. By means of this provision, the diverging nozzle is film-cooled.

Advantageously, the ejection orifices are arranged at the bottom ends of said feed channels.

In certain embodiments, a sealing gasket is arranged between an outer wall of the diverging portion of the combustion chamber and a facing inside wall of the thermostructural composite material shell.

By means of these provisions, the sealing gasket prevents hot gas from the combustion chamber penetrating into the gap between the outside wall of the combustion chamber and the inside wall of the thermostructural composite material shell. The gasket may be replaced by a filler resin between the combustion chamber and the outer shell.

In certain embodiments, at least a portion of the outer reinforcing shell is formed by a woven fabric of carbon fibers coated in a solidified resin, such as an epoxy or a phenolic resin.

In certain embodiments, at least a portion of the outer reinforcing shell is formed by a winding of carbon fibers included in a coating of solidified resin.

By means of these provisions, the structure of the propulsion chamber is lightened while providing reinforcement that withstands the pressure that exists inside the combustion chamber.

Advantageously, the resin makes it possible to obtain good adhesion between the outer reinforcing shell and the thermostructural composite material shell.

The invention also provides a method of fabricating a rocket propulsion chamber, the method being characterized in that it comprises the following steps:
shaping a single-piece shell made of thermostructural composite material and comprising a dome and a substantially cylindrical segment that is extended by a frustoconical segment;
hardening said shell;
making a radially strong outer reinforcing shell on a portion of said thermostructural composite material shell, the thermostructural composite material shell and the outer reinforcing shell forming a unitary assembly via a diverging nozzle constituted by a bottom portion of said frustoconical segment;
inserting a combustion chamber having a cooling circuit into the unitary assembly; and
holding the combustion chamber axially inside the unitary assembly with an abutment providing a bearing surface for said combustion chamber and fastened to the inside of the top part of said diverging nozzle, said diverging nozzle extending beyond a bottom end of a diverging portion of the combustion chamber.

The order in which some of the steps are performed may be modified.

Preferably, the unitary assembly is initially fabricated in parallel with the combustion chamber, the combustion chamber then being inserted into and held inside the unitary assembly. Clearance necessarily exists between the combustion chamber and the unitary assembly, and it is sealed against rising gas by a resin or by a silicone material.

In certain implementations, the invention provides a method of fabricating a rocket propulsion chamber further including the step of treating the unitary assembly in an autoclave.

The purpose of this step is to include the carbon fibers in a resin coating and to make the outer reinforcing shell adhere to the thermostructural composite material shell.

Treating in the autoclave also serves to solidify the outer reinforcing shell and to impart the necessary radial strength thereto.

In certain implementations, the invention provides a method of fabricating a rocket propulsion chamber including the step of connecting an inlet tube for a first propellant to the cooling circuit of the combustion chamber through an opening formed in the unitary assembly.

In certain implementations, the invention provides a method of fabricating a rocket propulsion chamber wherein at least a portion of the outer reinforcing shell is formed by a woven fabric of carbon fibers coated in a solidified resin.

In certain implementations, the invention provides a method of fabricating a rocket propulsion chamber wherein at least a portion of the outer reinforcing shell is formed by a winding of carbon fibers included in a coating of solidified resin.

The resin is solidified as a result of the step of treating in the autoclave.

Several embodiments are described in the present description. Nevertheless, unless specified to the contrary, the characteristics described with reference to any one embodiment may be applied to another embodiment or implementation.

### BRIEF DESCRIPTION OF THE DRAWINGS

The invention and its advantages can be better understood on reading the following detailed description of various embodiments of the invention given as non-limiting examples. The description refers to the accompanying figures, in which:

FIG. 1 is a section view in elevation of a propulsion chamber of the invention;

FIG. 2 is a detail view of Figure showing the inlet tube for admitting a first propellant into an annular cavity;

FIG. 3 is a fragmentary perspective view of the wall of the diverging portion of the combustion chamber, showing feed channels and the bottom ends of cooling channels;

FIG. 4 is a cutaway diagrammatic fragmentary view seen looking along arrow IV of FIG. 1; and

FIGS. 5A to 5G show a succession of fabrication steps for the FIG. 1 combustion chamber.

### DETAILED DESCRIPTION OF EMBODIMENTS

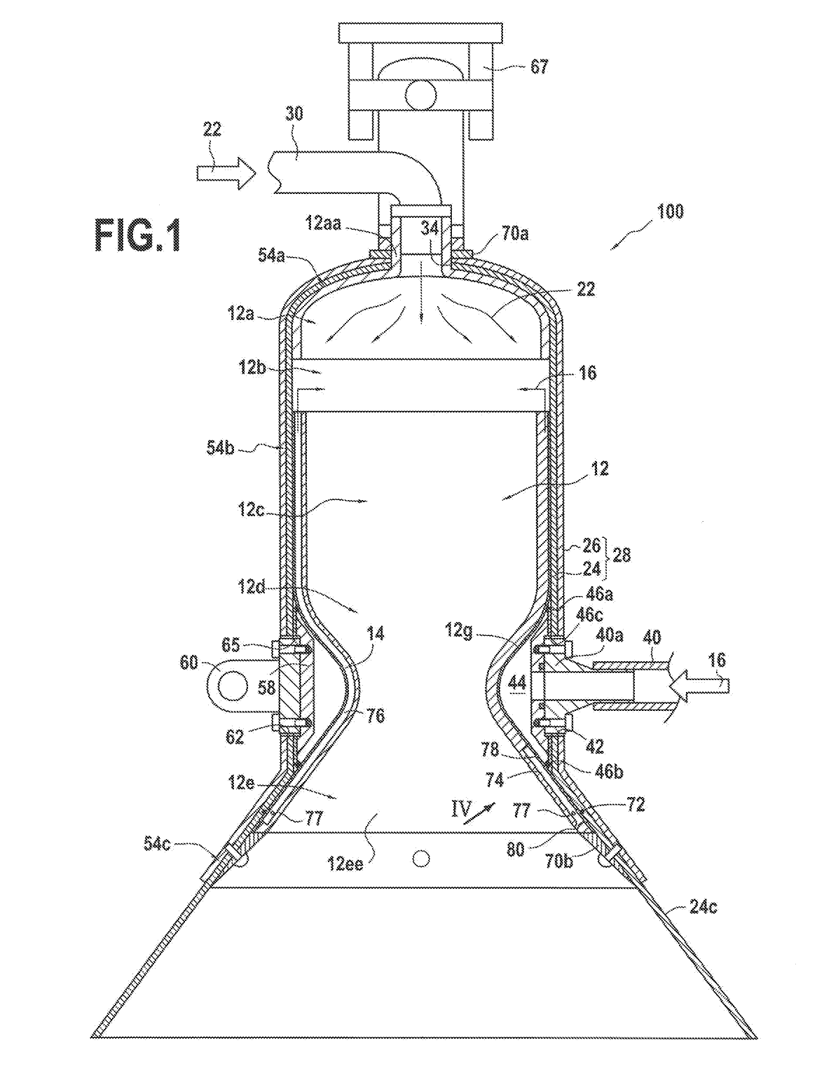

A rocket propulsion chamber of the invention is described with reference to FIGS. 1 to 4.

FIG. 1 is an elevation view in section of a propulsion chamber 100 of the invention. The propulsion chamber 100 comprises a metal combustion chamber 12, e.g. made of copper alloy. The combustion chamber 12 comprises in succession from its top portion to its bottom portion: a dome 12a; a set of injectors 12b; a substantially cylindrical portion 12c; a converging portion 12d; and a diverging portion 12e. In addition, a cooling circuit 14 is defined in the thickness of the wall of the combustion chamber 12 for passing a flow of a first propellant 16, liquid hydrogen in this example.

The cooling circuit 14 is essentially made up of channels comprising grooves machined in the thickness of the wall of the combustion chamber 12. In this example, the wall of the combustion chamber 12 has a covering 12g, made of metal in this example, e.g. of nickel or of copper-based metal alloy, serving to individualize and seal said channels by covering the grooves.

In addition, the dome 12a of the combustion chamber 12 is fed with a second propellant 16, liquid oxygen in this example, as explained below.

A shell 24 made as a single piece of thermostructural composite material, e.g. of carbon-silicon, is placed against the outside of the combustion chamber 12.

The thermostructural composite material shell 24 comprises a dome 54a, and a substantially cylindrical segment 54b that is extended by a frustoconical segment 54c. The frustoconical segment portion 54c extending beyond the bottom end 12ee of the diverging portion 12e of the combustion chamber 12 constitutes a diverging nozzle 24c of the propulsion chamber 100.

The propulsion chamber 100 of the invention further comprises an outer reinforcing shell 26 covering at least a portion of the thermostructural composite material shell 24. In this example, the outer reinforcing shell 26 covers the portion of the thermostructural composite material shell 24 that faces the dome 12a, the set of injectors 12b, and the cylindrical, converging, and diverging portions 12c, 12d, and 12e of the combustion chamber 12. In the present example, the outer reinforcing shell 26 is made as a winding of carbon fibers included in a coating of solidified resin.

In a variant, the shell 26 is made of a woven fabric of carbon fibers coated in solidified resin.

Thus, the thermostructural composite material shell 24 and the outer reinforcing shell 26 form a unitary assembly 28.

A feed pipe 30 for the second propellant 22 is connected to a tubular inlet 12aa of the dome 12a engaged in a hole 34 formed in the top portion of the unitary assembly 28.

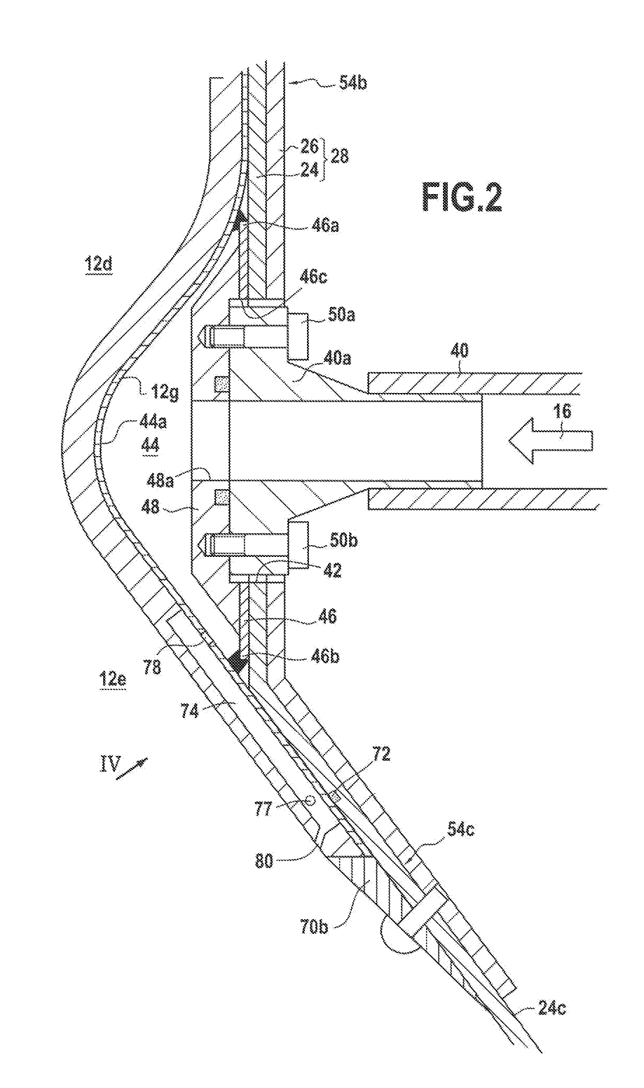

In addition, an inlet tube 40 for the first propellant 16, and that is fitted at its end with a plate 40a, passes through the unitary assembly 28 via an opening 42 arranged in the unitary assembly 28 so as to be connected to the cooling circuit 14. The opening 42 is arranged facing the junction between the converging portion 12d and the diverging portion 12e of the combustion chamber 12. As shown in greater detail in FIG. 2, the inlet tube 40 for the first propellant 16 provided with the plate 40a opens out into an annular cavity 44 having an inside face 44a that forms a portion of the wall of the combustion chamber 12, and more specifically in this example a portion of the covering 12g of the wall of the combustion chamber 12.

The annular cavity 44 is closed by a shroud 46, e.g. made of metal, which is fastened by its two end portions 46a and 46b to the covering 12g of the wall of the combustion chamber 12, e.g. by welding, the shroud 46 being surrounded by the unitary assembly 28. Furthermore, the shroud 46 is provided with an opening 46c facing the opening 42 formed in the unitary assembly so that the plate 40a penetrates through the opening 46c of the shroud 46. In addition, the inside face of the shroud 46 carries a fastener plate 48, e.g. made of metal, against which the plate 40a bears. The fastener plate 48 is also provided with an opening 48a facing the opening 46c in the shroud 46 so as to enable the first propellant 16 to pass into the annular cavity 44. Thereafter the inlet tube 40 is fastened to the fastener plate 48 e.g. by bolts 50a and 50b inserted in the plate 40a and screwed into respective tapped holes in the fastener plate 48.

The inside face of the shroud 46 also carries two bases 58 each of which has a connection tab 60 of a control actuator fastened thereto. Each connection tab 60 passes through a respective opening 62 formed in the unitary assembly 28 and through an opening 65 formed in the shroud 46. In preferred manner, the two connection tabs 60 are circumferentially offset by 90° in order to optimize guidance of the propulsion chamber 100, which is then transmitted via gimbal joint 67 to the remainder of the rocket. That is why only one base 58 and only one connection tab 60 can be seen in FIG. 1.

The combustion chamber 12 is axially fastened in the unitary assembly 28 by means of a first abutment 70a and a second abutment 70b. In this example, the first abutment 70a is a nut screwed onto a thread arranged at the inlet 12aa of the dome 12a so that when the first abutment 70a is screwed onto said thread it bears against the unitary assembly 28. In addition, the second abutment 70b, in this example an annular wedge, is fastened on the inside wall of the top of the diverging nozzle 24c so that the combustion chamber 12 bears against the second abutment 70b.

Furthermore, as shown in FIGS. 1 and 2, a sealing gasket 72 is arranged under the annular cavity between the outside wall of the diverging portion 12e of the combustion chamber 12 and the inside wall of the thermostructural composite material shell 24.

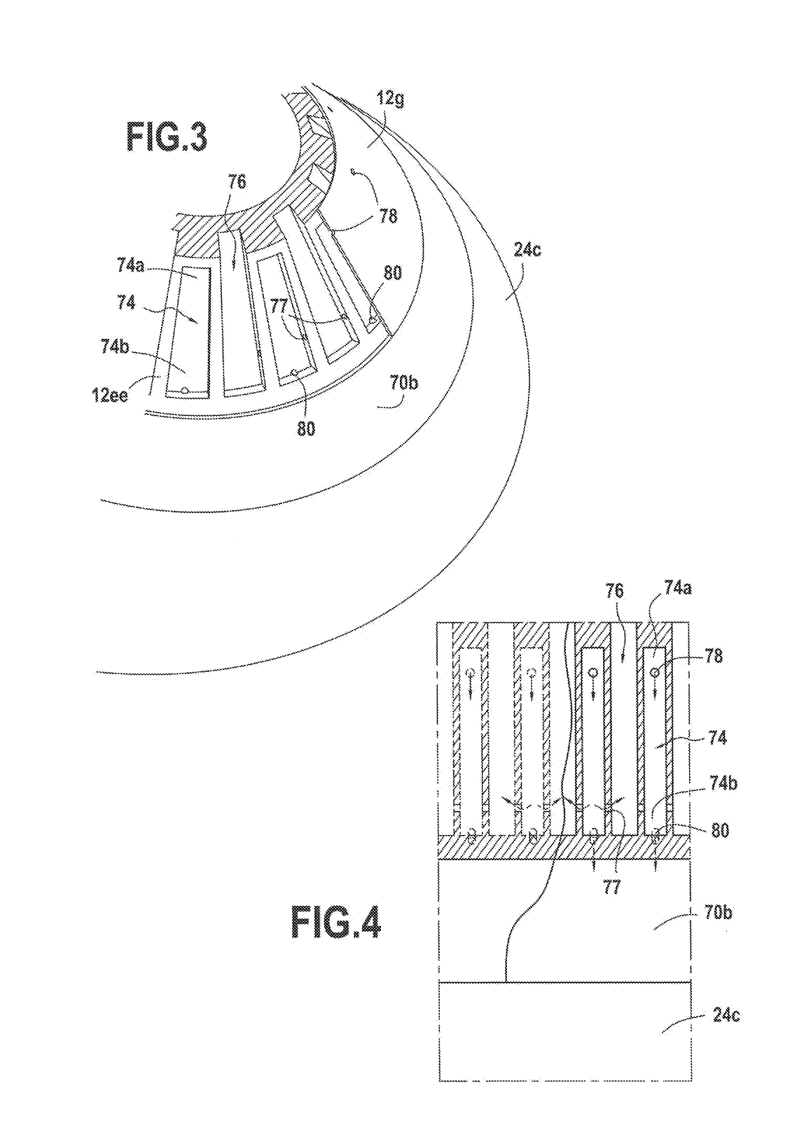

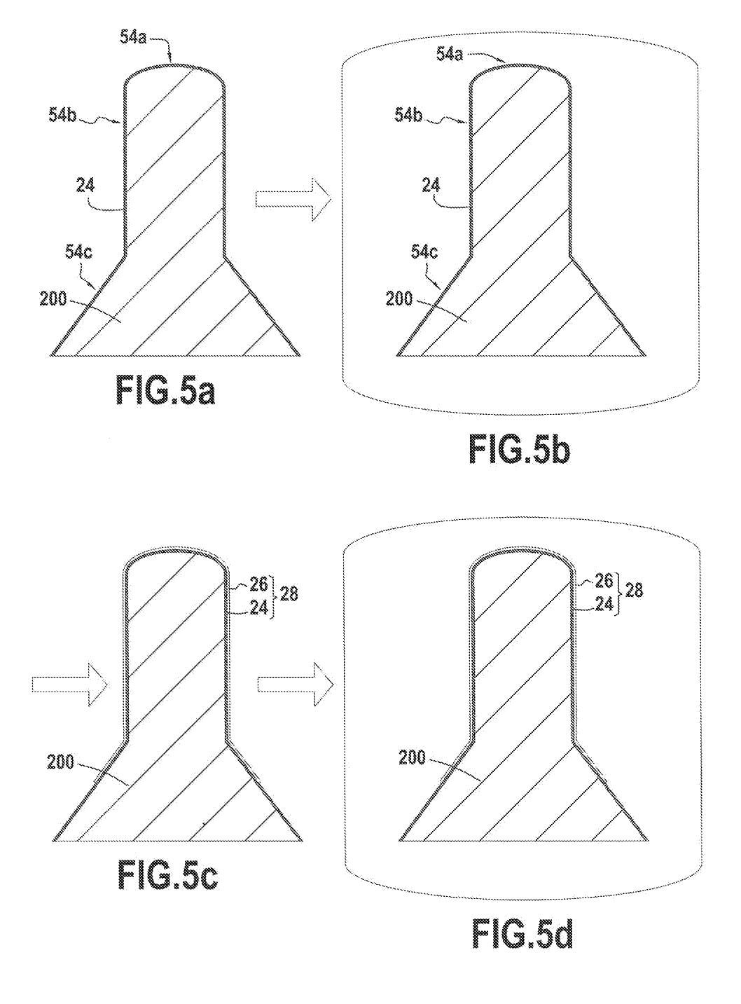

As mentioned above, the cooling circuit 14 of the propulsion chamber 100 is defined in the thickness of the wall of the combustion chamber 12. As shown in FIGS. 3 and 4, said cooling circuit 14 comprises feed channels 74 and cooling channels 76 that are machined in the thickness of the wall of the combustion chamber 12.

The feed channels 74 extend in the diverging portion 12e of the combustion chamber 12 and communicate at their top ends 74a with the annular cavity 44 via holes 78 through the covering 12g of the wall of the combustion chamber 12. The feed channels 74 thus extend between their top ends 74a in communication with the holes 78 and their bottom ends 74b that are situated in this example substantially at the bottom end 12ee of the diverging portion 12e of the combustion chamber 12. In these feed channels 74, the first propellant 16 flows downwards.

As shown in FIGS. 3 and 4, a fraction of the first propellant 16 is ejected via ejection orifices 80 opening out along the inside surface of the diverging nozzle 24c. Thus, the first propellant flows along the inside surface of the second abutment 70b and then flows along the inside surface of the diverging nozzle 24c.

Another fraction of the first propellant 16 reaching the bottom ends 74b of the feed channels 74 penetrates into the cooling channels 76 via passages 77 and rises to the set of injectors 12b, with the first propellant 16 flowing upwards.

The first and second propellants 16 and 22 penetrate into the set of injectors 12a in order to be mixed together therein. Combustion takes place in the cylindrical portion 12c of the combustion chamber 12.

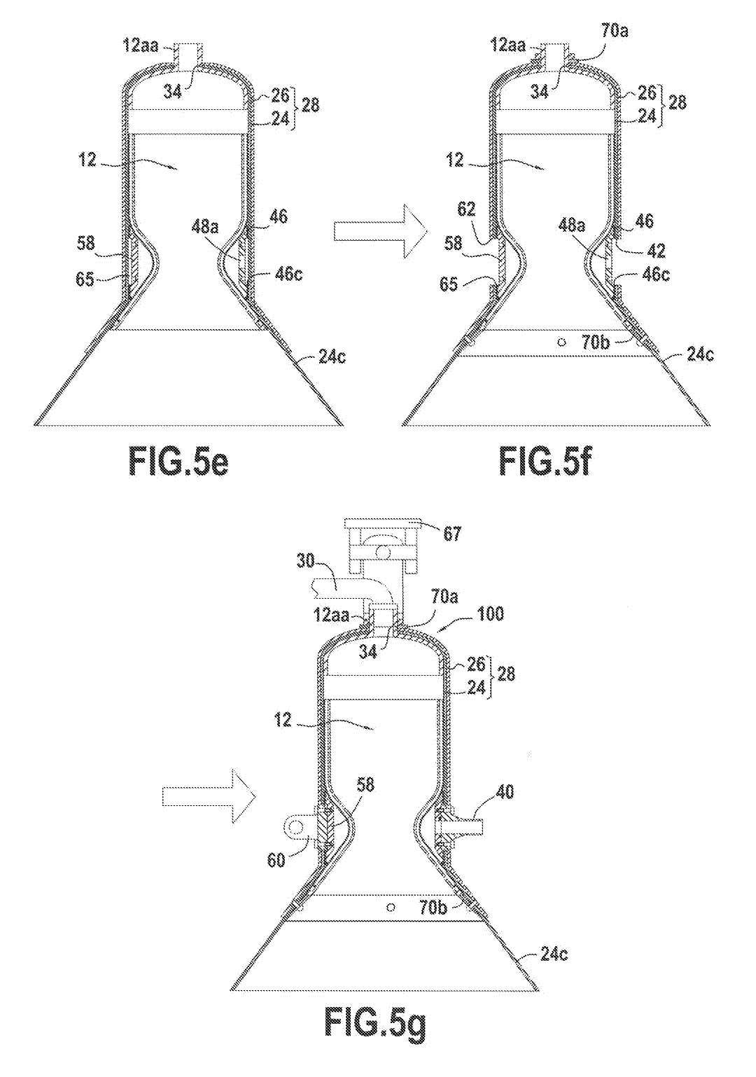

In an implementation of the invention, FIGS. 5a to 5g show the various steps of the method of fabricating the propulsion chamber of the invention.

The combustion chamber 12, which is made in conventional manner, is not described in detail herein independently of the process described below.

More specifically, the shroud 46, formed by two half-shrouds, closes the annular cavity 44 of the combustion chamber 12. To do this, the fastener plate 48 is previously fastened to the inside face of one half-shroud, with the two bases 58 also being fastened to the inside face of the other half-shroud. Thus, the two half-shrouds carrying the fastener plate 48 and the two bases 58 internally are positioned around the annular cavity 44 of the combustion chamber 12 and are welded together longitudinally. Thereafter, the two ends 46a and 46b of the shroud 46 are welded circumferentially to the covering 12c of the wall of the combustion chamber 12.

During a first step of the method of fabricating the propulsion chamber 100 (see FIG. 5A), the thermostructural composite material shell 24 is shaped from a single piece of thermostructural composite material. To do this, the thermostructural composite material shell 24 is shaped on a mold 200 such that thermostructural composite material shell 24 possesses a dome 54a, and a substantially cylindrical segment 54b that is extended by a frustoconical segment 54c.

In a second step of the fabrication method (see FIG. 5B), the thermostructural composite material shell 24, still in position on the preform 200, is cured, e.g. by pyrolysis.

In a third step of the fabrication method (see FIG. 5C), the radially strong outer reinforcing shell 26 is made on a portion of the thermostructural composite material shell 24. In preferred manner, the outer reinforcing shell 26 is made over all of the dome 54a and the cylindrical segment 54b, and over a top fraction of the frustoconical segment 54c of the thermostructural composite material shell 24, such that the outer reinforcing shell 26 envelops the dome 12a, the injector assembly 12b and also the substantially cylindrical, converging, and diverging portions 12c, 12d, and 12e of the combustion chamber 12. As mentioned above, the outer reinforcing shell 26 may be a winding of carbon fibers coated in resin or it may be a woven fabric of carbon fibers included in a resin coating.

In a fourth step of the fabrication method (see FIG. 5d), the unitary assembly 28 formed by the thermostructural composite material shell 24 and the outer reinforcing shell 26 is treated in an autoclave in order to polymerize the resin of the outer reinforcing shell 26. The effect of polymerization is to agglomerate the carbon fibers and the resin, and to cause the outer reinforcing shell 26 to adhere to the thermostructural composite material shell 24. Polymerization also serves to solidify the outer reinforcing shell and to impart the needed radial strength thereto.

In a fifth step of the fabrication method (see FIG. 5E), the unitary assembly 28 is separated from the mold 200. The combustion chamber 12 with the shroud 46 is then inserted via the diverging nozzle into the unitary assembly 28.

In addition, when the combustion chamber 12 together with the shroud 46 is inserted in the unitary assembly 28, there is necessarily clearance between the combustion chamber 12 with the shroud 46 and the unitary assembly 28. Said clearance may be filled in with a resin or a silicone material where gas might rise.

In addition, before inserting the combustion chamber, the hole 34 is formed in the unitary assembly 28 in order to pass the inlet 12aa of the dome 12a.

In a sixth step of the fabrication method (see FIG. 5F), the combustion chamber 12 with the shroud 46 is held axially by the first and second abutments 70a and 70b.

The opening 42 is also formed in the unitary assembly 28 facing the junction between the converging portion 12d and the diverging portion 12e of the combustion chamber. This reveals the openings 46c and 48a formed respectively in the shroud 46 and the fastener plate 48. This also reveals the holes 65 formed in the shroud 46. In addition, the openings 62 are formed in the unitary assembly 28.

Finally, in a seventh step of the fabrication method (see FIG. 5G), the inlet tube 40 for the first propellant 16 is connected to the cooling circuit via the opening 42 so that it bears against the fastener plate 48. In addition, the connection tabs 60 are positioned on the respective bases 58. The feed duct 30 for the second propellant 20 is connected to the inlet 12aa of the dome 12a. In addition, the gimbal joint 67 is mounted on the propulsion chamber.

Although the present invention is described with reference to specific embodiments, it is clear that modifications and changes may be made to those embodiments without leaving the general ambit of the invention as defined by the claims. In particular, individual characteristics of the various embodiments shown and/or described may be combined in additional embodiments. Consequently, the description and the drawings should be considered in a sense that is illustrative rather than restrictive.

1. A rocket propulsion chamber, comprising:
a combustion chamber, a wall of the combustion chamber having a cooling circuit in which a first propellant flows, a single-piece thermostructural composite material shell placed against an outside of said combustion chamber and including a diverging nozzle extending beyond the bottom end of the combustion chamber;
a radially strong outer reinforcing shell covering at least a fraction of said single-piece thermostructural composite material shell for containing deformation of the combustion chamber and of said single-piece thermostructural composite material shell, the single-piece thermostructural composite material shell and the radially strong outer reinforcing shell, forming a unitary assembly; and
said combustion chamber bearing against an abutment fastened to an inside of a top part of the diverging nozzle.

2. The propulsion chamber according to claim 1, wherein the combustion chamber comprises in succession a dome for admitting a second propellant, a set of injectors, a substantially cylindrical portion extended by a converging portion and by a diverging portion, an inlet of the dome for admitting the second propellant constituting a top end of the combustion chamber and being connected to a feed duct for the second propellant and the single-piece thermostructural composite material shell also having a dome surmounting the dome of the combustion chamber.

3. The propulsion chamber according to claim 2, wherein the combustion chamber is held in said unitary assembly between an abutment fastened to the top end of the combustion chamber through which said feed duct for the second propellant passes, bearing against a top of said unitary assembly, and the abutment fastened to an inside of top part of the diverging nozzle.

4. The propulsion chamber according to claim 1, wherein an inlet tube for the first propellant is connected to the cooling circuit of the combustion chamber and passes through an opening formed in the unitary assembly.

5. The propulsion chamber according to claim 4, wherein the inlet tube for the first propellant opens out into an annular cavity having an inside face forming a portion of the wall of the combustion chamber situated at the junction between the converging portion and the diverging portion of the combustion chamber.

6. The propulsion chamber according to claim 5, wherein the annular cavity is closed by a shroud that is fastened at two axial ends to the wall of the combustion chamber, the shroud being surrounded by the unitary assembly and being pierced to pass the an end of the inlet tube for the first propellant.

7. The propulsion chamber according to claim 6, wherein the shroud carries internally a fastener plate having connected thereto the end of the inlet tube for the first propellant, the fastener plate including an opening for passing the first propellant.

8. The propulsion chamber according to claim 6, wherein the shroud carries internally at least two bases, each of which has a respective connection tab of a control actuator fastened thereto through a respective opening formed in the unitary assembly.

9. The propulsion chamber according to claim 8, wherein the two connection tabs are offset circumferentially from each other by 90°.

10. The propulsion chamber according to claim 5, wherein the cooling circuit comprises:
cooling channels formed in the wall of the combustion chamber, in which the first propellant flows upwards, these cooling channels extending between a bottom end of the diverging portion of the combustion chamber and a set of injectors arranged in the top portion of the combustion chamber; and
feed channels in the wall of the combustion chamber extending into the diverging portion of the combustion chamber and in which the first propellant flows downwards, said feed channels communicating at top ends via holes with the annular cavity, and via bottom ends with the set of cooling channels.

11. The propulsion chamber according to claim 10, wherein the feed channels communicate with ejection orifices for passing a flow of the first propellant.

12. The propulsion chamber according to claim 1, wherein a sealing gasket is arranged between an outer wall of the diverging portion of the combustion chamber and a facing inside wall of the single-piece thermostructural composite material shell.

13. The propulsion chamber according to claim 1, wherein at least a portion of the radially strong outer reinforcing shell is formed by a woven fabric of carbon fibers coated in a solidified resin.

14. The propulsion chamber according to claim 1, wherein at least a portion of the radially strong outer reinforcing shell is formed by a winding of carbon fibers included in a coating of solidified resin.

15. A method of fabricating a rocket propulsion chamber, the method comprising:
shaping a single-piece shell made of thermostructural composite material and comprising a dome and a substantially cylindrical segment that is extended by a frustoconical segment;
hardening said shell;
making a radially strong outer reinforcing shell on a portion of said single-piece shell, the single-piece shell and the radially strong outer reinforcing shell forming a unitary assembly;
inserting a combustion chamber having a cooling circuit into the unitary assembly via a diverging nozzle constituted by a bottom portion of said frustoconical segment; and
holding the combustion chamber axially inside the unitary assembly with an abutment providing a bearing surface for said combustion chamber and fastened to the inside of the top part of said diverging nozzle, said diverging nozzle extending beyond a bottom end of a diverging portion of the combustion chamber.

16. The method of fabricating a propulsion chamber according to claim 15, further including treating the unitary assembly in an autoclave.

17. The method of fabricating a propulsion chamber according to claim 15, including connecting an inlet tube for a first propellant to the cooling circuit of the combustion chamber through an opening formed in the unitary assembly.

18. The method of fabricating a propulsion chamber according to claim 15, wherein at least a portion of the outer reinforcing shell is formed by a woven fabric of carbon fibers coated in a solidified resin.

19. The method of fabricating a propulsion chamber according to claim 15, wherein at least a portion of the outer reinforcing shell is formed by a winding of carbon fibers included in a coating of solidified resin.
